(19) United States
(12) Patent Application Publication
(10) Pub. No.: US 2016/0003616 A1
(43) Pub. Date: Jan. 7, 2016

(54) ANGULAR VELOCITY SENSOR

(71) Applicant: Asahi Kasei Kabushiki Kaisha, Tokyo (JP)

(72) Inventor: Seiichi KATO, Tokyo (JP)

(73) Assignee: ASAHI KASEI KABUSHIKI KAISHA, Tokyo (JP)

(21) Appl. No.: 14/858,044

(22) Filed: Sep. 18, 2015

Related U.S. Application Data
(63) Continuation of application No. PCT/JP2014/001298, filed on Mar. 7, 2014.

(30) Foreign Application Priority Data
Mar. 29, 2013 (JP) 2013-073836

(51) Int. Cl. G01C 19/56

(52) U.S. Cl. CPC G01C 19/56

(57) ABSTRACT

An angular velocity sensor comprising: a drive circuit to generate a drive signal; a vibrating weight; a vibrating unit to vibrate the vibrating weight along a first axis and a second axis according to the drive signal; an output unit to output a signal based on Coriolis force that occurs corresponding to angular velocity and vibration of the vibrating weight; a detection circuit to detect the angular velocity from the signal based on the Coriolis force; a first vibration attenuating unit to electrically consume kinetic energy of the vibrating weight is provided.

### BACKGROUND

1. Technical Field

The present invention relates to an angular velocity sensor. In particular, the present invention relates to an angular velocity sensor that attenuates vibration of a vibrating weight.

2. Related Art

An angular velocity sensor can measure angular velocity of different rotational axes by switching the vibration direction of a vibrator. When switching the vibration direction of the vibrator in the angular velocity sensor, the angular velocity cannot be measured accurately during an attenuation interval that is until vibration in a pre-switching vibration direction ends and during a rising interval that is until vibration in a post-switching vibration direction becomes steady. For this reason, it is required to make the rising interval and the attenuation interval short for the purpose of completing angular velocity measurement in a short time. A conventional angular velocity sensor shortens measurement time by making a rising interval of a vibrator short by means of pulse driving or the like (see Patent Literature 1, for example).
[Patent Literature 1] Japanese Patent Application Publication No. H9-33262

However, in a method of making a rising interval of a vibrator short, the amount of time by which switching time of the vibration direction can be shortened is limited to the rising interval of the vibrator at the most. Also, if a circuit or the like to generate a signal to move a vibrator in an opposite direction to vibration when the vibration is attenuated is additionally provided in order to shorten an attenuation interval, current is wastefully consumed.

### SUMMARY

Therefore, it is an object of an aspect of the innovations herein to provide an angular velocity sensor, which is capable of overcoming the above drawbacks accompanying the related art. The above and other objects can be achieved by combinations described in the claims. That is, a first aspect of the present invention provides an angular velocity sensor comprising: a drive circuit to generate a drive signal; a vibrating weight; a vibrating unit to vibrate the vibrating weight along a first axis and a second axis according to the drive signal; an output unit to output a signal based on Coriolis force that occurs corresponding to angular velocity and vibration of the vibrating weight; a detection circuit to detect the angular velocity from the signal based on the Coriolis force; a first vibration attenuating unit to electrically consume kinetic energy of the vibrating weight.

The summary clause does not necessarily describe all necessary features of the embodiments of the present invention. The present invention may also be a sub-combination of the features described above.

### BRIEF DESCRIPTION OF THE DRAWINGS

FIG. 1 is a figure illustrating the overview of a sensor package 300.

FIG. 2 is a figure illustrating an operation of switching the vibration direction of a vibrating weight 342.

FIG. 3 is a figure illustrating a configuration example of an angular velocity sensor 100 according to an embodiment of the present invention.

FIG. 4 is a figure illustrating a configuration example of the angular velocity sensor 100 according to an embodiment of the present invention.

FIG. 5 is a figure illustrating a configuration example of the angular velocity sensor 100 according to an embodiment of the present invention.

FIG. 6 is a circuit diagram illustrating an equivalent circuit of a piezoelectric element.

FIG. 7 is a circuit diagram illustrating an equivalent circuit of a piezoelectric element provided with an attenuating resistance 161.

### DESCRIPTION OF EXEMPLARY EMBODIMENTS

Hereinafter, (some) embodiment(s) of the present invention will be described. The embodiment(s) do(es) not limit the invention according to the claims, and all the combinations of the features described in the embodiment(s) are not necessarily essential to means provided by aspects of the invention.

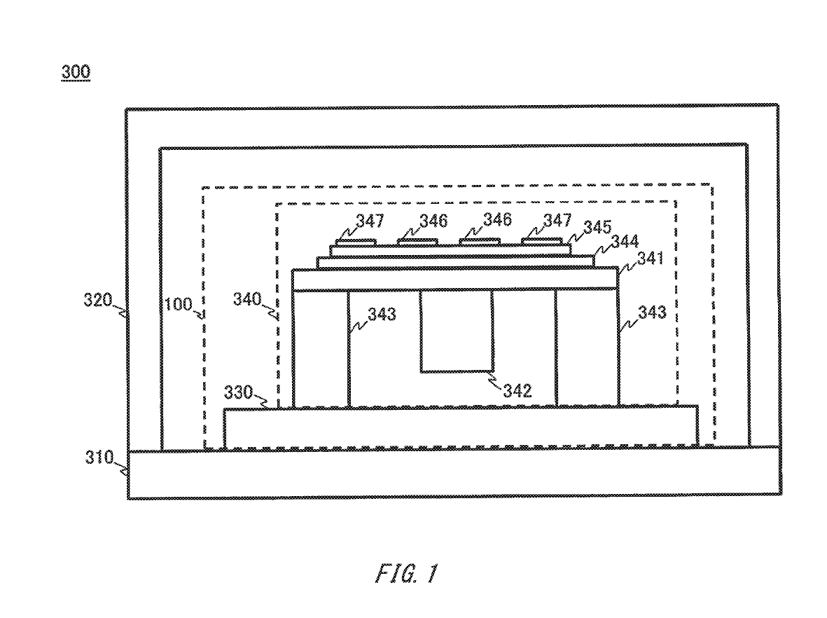

FIG. 1 is a figure illustrating the overview of a sensor package 300. The sensor package 300 includes a package substrate 310, a case 320, an ASIC 330 and a MEMS 340. In the present specification, the ASIC 330 and the MEMS 340 are collectively called an angular velocity sensor 100.

The angular velocity sensor 100 detects angular velocity of the angular velocity sensor 100 based on Coriolis force that occurs corresponding to vibration and the angular velocity of the MEMS 340. Coriolis force is inertial force that occurs perpendicularly to a vibration direction of the MEMS 340 when it is vibrated in the sensor package 300 having angular velocity.

The ASIC 330 and the MEMS 340 are stacked sequentially on the top surface of the package substrate 310. The case 320 is placed on the package substrate 310 so as to cover the ASIC 330 and the MEMS 340 completely.

The ASIC 330 outputs a drive signal to vibrate the MEMS 340. Also, the ASIC 330 detects Coriolis force that occurs in a perpendicular direction to the direction of vibration of the MEMS 340 due to the drive signal, and measures the angular velocity of the MEMS 340. The ASIC 330 performs signal processing on an output corresponding to the Coriolis force occurring to the MEMS 340 in a perpendicular direction to the direction of vibration of the MEMS 340 due to the drive signal.

The MEMS 340 includes a planar substrate 341, a vibrating weight 342, a housing 343, a lower electrode 344, a piezoelectric body 345, drive electrodes 346, and detection electrodes 347. The vibrating weight 342 of the MEMS 340 vibrates according to the drive signal from the ASIC 330. At this time, Coriolis force corresponding to the angular velocity and the vibration direction of the vibrating weight 342 occurs to the vibrating weight 342. The detection electrodes 347 output a signal corresponding to the Coriolis force that has occurred.

The MEMS 340 is manufactured by performing a semiconductor manufacturing process for example on a SOI substrate having a triple layer structure such as Si—SiO₂—Si. The planar substrate 341 formed with a first Si layer has a fixed outer periphery, and vibrates according to a drive signal.

The vibrating weight 342 is formed to extend in a perpendicular direction to the planar substrate 341 by performing depth etching on a second Si layer in the SOI substrate. The vibrating weight 342 according to the present example is formed to extend from the middle of the bottom surface of the planar substrate 341 toward the top surface of the ASIC 330. The vibrating weight 342 for example has a cylindrical, elliptic cylindrical or other shape. The vibrating weight 342 vibrates according to a drive signal in a unified manner with the planar substrate 341.

The housing 343 is formed to be unified with the planar substrate 341 at the outer periphery of the planar substrate 341 by performing depth etching on the second Si layer in the SOI substrate. Also, the housing 343 is formed simultaneously with formation of the vibrating weight 342. Note that the housing 343 may be formed separately from the planar substrate 341, and fixed on the planar substrate 341 by adhesion or the like. The housing 343 supports the outer periphery of the planar substrate 341 when the vibrating weight 342 vibrates. The housing 343 preferably is not displaced corresponding to vibration of the vibrating weight 342. Thereby, the vibrating weight 342 can stably vibrate in a predetermined rotational axis direction.

The lower electrode 344 and the piezoelectric body 345 are formed to be stacked on the top surface of the planar substrate 341. The lower electrode 344 and the piezoelectric body 345 are formed to cover an area which is in the planar substrate 341 but not fixed to the housing 343. Also, the drive electrodes 346 and the detection electrodes 347 are respectively provided on the top surface of the piezoelectric body 345.

Voltage is applied to the lower electrode 344 such that the voltage becomes constant. For example, the lower electrode 344 is grounded. Also, voltage corresponding to a direction in which the vibrating weight 342 is vibrated is applied to the drive electrodes 346. Thereby, the piezoelectric body 345 is bent corresponding to the difference between the voltage of a drive signal input to the drive electrodes 346 and the voltage of the lower electrode 344.

The drive electrodes 346 are placed on the top surface of the piezoelectric body 345 and in the vicinity of a position corresponding to the outer periphery of the vibrating weight 342. Because the distance from the inner periphery of the housing 343 which is the fixed end of vibration becomes the longest at the outer periphery of the vibrating weight 342, a large moment occurs to the piezoelectric body 345 near the outer periphery of the vibrating weight 342. Accordingly, the drive electrodes 346 can vibrate the vibrating weight 342 more efficiently as compared with a case where they are provided in the proximity of the housing 343.

The detection electrodes 347 are placed on the top surface of the piezoelectric body 345 and in the vicinity of a position corresponding to the inner periphery of the housing 343. Because the closer the piezoelectric body 345 is to the housing 343, the larger the stress applied at the time of vibration is, large current occurs to the piezoelectric body 345 near the inner periphery of housing 343. Accordingly, the detection electrodes 347 can detect a larger signal when they are provided at positions close to the housing 343 as compared with a case where they are provided at positions close to the vibrating weight 342.

A signal detected by the detection electrodes 347 is a signal based on Coriolis force occurring corresponding to a vibration direction of the vibrating weight 342 and angular velocity of the MEMS 340. The ASIC 330 performs signal processing on an output based on the Coriolis force and detects the angular velocity.

The sensor package 300 according to the present embodiment can detect the angular velocity of a plurality of rotational axes by switching the vibration direction of the vibrating weight 342. Specifically, the sensor package 300 vibrates the vibrating weight 342 intermittently and switches the vibration direction from the first axis to the second axis. The sensor package 300 measures the angular velocity of each rotational axis at a given time by repeating the switching operation.

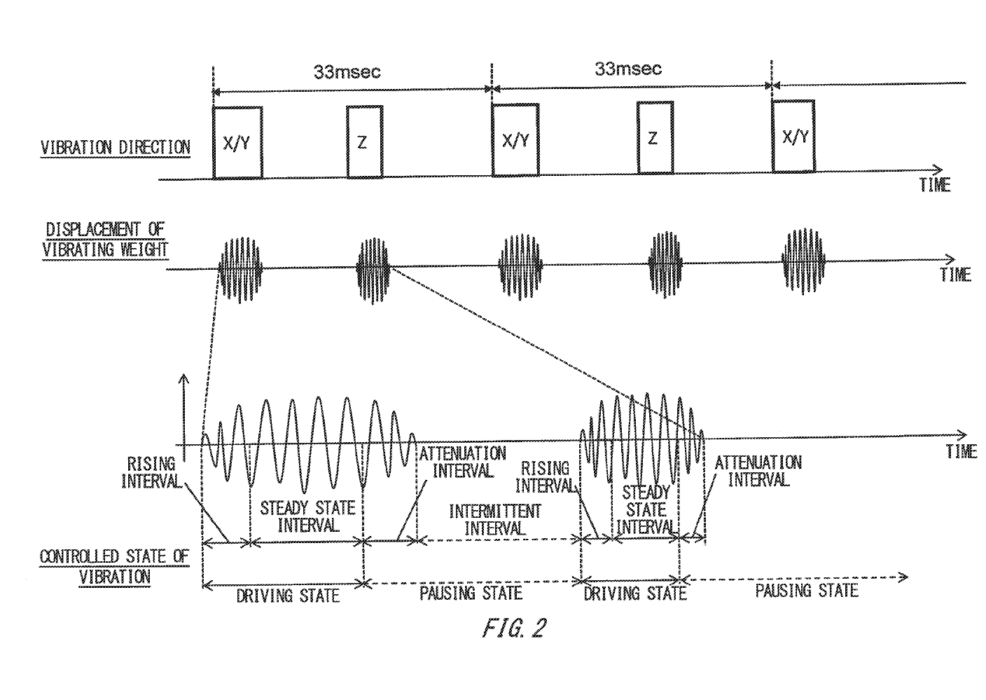

FIG. 2 is a figure illustrating an operation of switching the vibration direction of the vibrating weight 342. The vibration direction of the vibrating weight 342 is switched intermittently between the first axis and the second axis. The first axis or the second axis is a perpendicular direction to the planar substrate 341. Also, the first axis and the second axis are orthogonal to each other. Assuming that two rotational axes that are orthogonal to each other within a plane parallel with the planar substrate 341 are the x-axis and the y-axis, and a rotational axis perpendicular to the planar substrate 341 is the z-axis, the first axis is the x-axis or the y-axis and the second axis is the z-axis in the present embodiment.

For example, the angular velocity sensor 100 detects the angular velocity in the z-axis direction and the y-axis direction when the vibrating weight 342 is vibrated in the x-axis direction. In the present specification, the angular velocity in the z-axis direction refers to the angular velocity of rotation about the z-axis. The angular velocity in the x-axis direction and the y-axis direction is defined in a similar manner In FIG. 2, X/Y indicates that the vibrating weight 342 is vibrated in the z-axis direction and Coriolis force in the x-axis and the y-axis direction is detected, and Z indicates that the vibrating weight 342 is vibrated in the x-axis or the y-axis direction and Coriolis force in the z-axis direction is detected.

Displacement of the vibrating weight 342 is divided into a rising interval, a steady state interval, an attenuation interval, and an intermittent interval. The rising interval refers to an interval that is from when a drive signal from the ASIC 330 is input to the MEMS 340 and the vibrating weight 342 starts vibrating and until when the amplitude becomes steady. The steady state interval refers to an interval during which a drive signal from the ASIC 330 is input to the MEMS 340, and the vibrating weight 342 vibrates at constant amplitude. The attenuation interval refers to an interval that is from when an input of a drive signal from the ASIC 330 to the MEMS 340 ends and until when the vibrating weight 342 no longer vibrates.

The intermittent interval is an interval during which the vibrating weight 342 does not vibrate. That is, the intermittent interval refers to an interval that is from when the attenuation interval ends and until when a next rising interval starts. Because vibration of the first axis and vibration of the second axis can be separated by providing the intermittent interval, they are not interfered by each other. Therefore, the angular velocity sensor 100 can measure angular velocity highly accurately.

The controlled state of vibration of the vibrating weight 342 can be divided into a driving state and a pausing state. The driving state corresponds to a state where the vibrating weight 342 is driven by a drive signal, and refers to a rising interval and a steady state interval. Also, the driving state corresponds to a state where a drive signal is input from the drive circuit 130 to at least one of a first vibrating unit 111 and a second vibrating unit 112 described below. The pausing state corresponds to a state where the vibrating weight 342 is not driven by a drive signal, and refers to an attenuation interval and an intermittent interval. Also, the pausing state corresponds to a state where a drive signal from the drive circuit 130 is not input to neither the first vibrating unit 111 nor the second vibrating unit 112 described below.

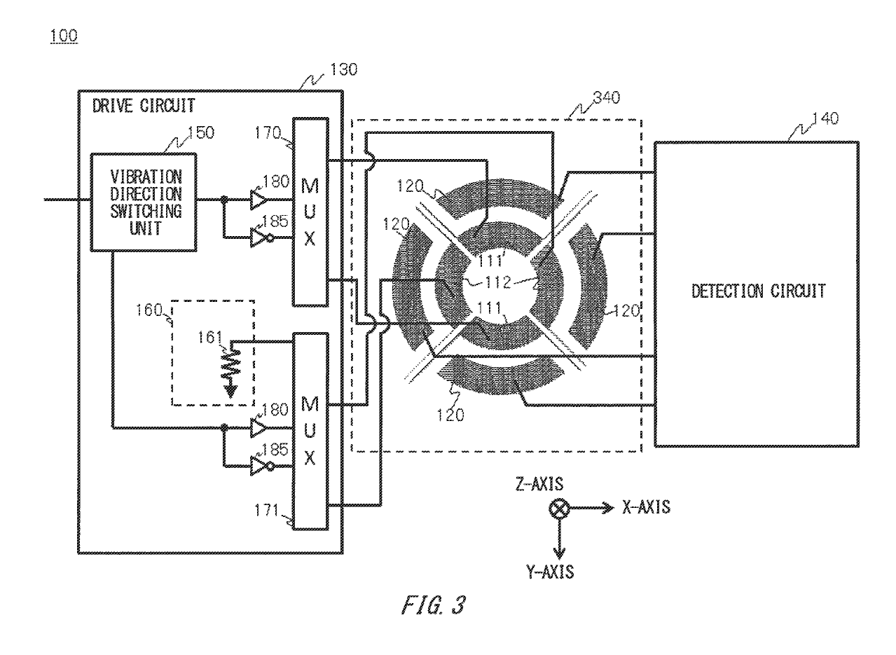

FIG. 3 is a figure illustrating a configuration example of the angular velocity sensor 100 according to an embodiment of the present invention. The angular velocity sensor 100 according to the present example is configured with the MEMS 340, a drive circuit 130 and a detection circuit 140. The drive circuit 130 and the detection circuit 140 are provided to the ASIC 330. The angular velocity sensor 100 detects angular velocity based on Coriolis force corresponding to vibration of the vibrating weight 342 and angular velocity.

The drive circuit 130 outputs a drive signal for vibrating the MEMS 340 along the first axis or the second axis to the MEMS 340. Here, the first axis and the second axis may be the x-axis and the z-axis, respectively. Note that in the present specification, the plane of the planar substrate 341 is defined as the xy plane.

In FIG. 3, the top surface of the MEMS 340 is shown. The MEMS 340 includes the vibrating weight 342, the first vibrating unit 111, the second vibrating unit 112 and an output unit 120. The first vibrating unit 111 and the second vibrating unit 112 correspond to the drive electrodes 346 shown in FIG. 1. Also, in the present specification, the first vibrating unit 111 and the second vibrating unit 112 are called simply a vibrating unit collectively in some cases.

The output unit 120 corresponds to the detection electrodes 347 shown in FIG. 1. The first vibrating unit 111, upon receiving a drive signal, vibrates the vibrating weight 342 along the first axis. The second vibrating unit 112, upon receiving a drive signal, vibrates the vibrating weight 342 along the second axis.

The output unit 120 detects a signal that occurs corresponding to vibration of the vibrating weight 342. The output unit 120 outputs a signal based on Coriolis force that occurs due to angular velocity and vibration of the vibrating weight 342. The output unit 120 according to the present example outputs an electronic signal obtained by converting the Coriolis force by means of the piezoelectric body 345. The output unit 120 can output Coriolis force in three axial directions because they include four electrodes placed on the x-axis and the y-axis.

The detection circuit 140 performs signal processing on an output from the output unit 120. The detection circuit 140 can detect angular velocity based on the output from the output unit 120. Specifically, the detection circuit 140 detects angular velocity according to a relationship between a signal based on the Coriolis force output by the output unit 120 and a drive signal output by the drive circuit 130.

The drive circuit 130 includes a vibration direction switching unit 150, a first vibration attenuating unit 160, a first switch unit 170 and a second switch unit 171. The vibration direction switching unit 150 is connected to the first vibrating unit 111 via the first switch unit 170. Also, the vibration direction switching unit 150 is connected to the second vibrating unit 112 via the second switch unit 171.

The vibration direction switching unit 150 switches between driving of the first vibrating unit 111 and driving of the second vibrating unit 112. Thereby, the vibration direction switching unit 150 switches the vibration direction of the vibrating weight 342 from one of the first axis and the second axis to the other. The vibration direction switching unit 150 may switch the vibration direction of the vibrating weight 342 by controlling the first switch unit 170 and the second switch unit 171.

A forward buffer 180 and an inverting buffer 185 are connected in parallel between the vibration direction switching unit 150 and the first switch unit 170. That is, signals that have the same phase with and the reverse phase to an output of the vibration direction switching unit 150 are input to the first switch unit 170.

The first switch unit 170 selects the forward buffer 180 and the inverting buffer 185 for each drive electrode of the first vibrating unit 111 and connects therebetween.

The second switch unit 171 makes the first vibration attenuating unit 160 and the second vibrating unit 112 conductive or non-conductive in a switching manner The second switch unit 171 according to the present example is a multiplexer to select any of the forward buffer 180, the inverting buffer 185 and the first vibration attenuating unit 160 for each drive electrode of the second vibrating unit 112, and connects therebetween.

The first vibrating unit 111 is arrayed on and along the y-axis, and includes one pair of drive electrodes that are opposite to each other with the middle of the planar substrate 341 being sandwiched therebetween. Also, the second vibrating unit 112 is arrayed on and along the x-axis, and includes one pair of drive electrodes that are opposite to each other with the middle of the planar substrate 341 being sandwiched therebetween. For example, when the vibrating weight 342 is vibrated in the x-axis direction, the two drive electrodes of the second vibrating unit 112 receive signals that have reverse phases to each other. At this time, each drive electrode of the first vibrating unit 111 does not receive a signal.

Also, when the vibrating weight 342 is vibrated in the z-axis direction, signals having the same phase are input to each drive electrode of the first vibrating unit 111 and the second vibrating unit 112. For example, the forward buffers 180 are connected to respective drive electrodes.

The second switch unit 171 connects the first vibration attenuating unit 160 with the second vibrating unit 112 via the second switch unit 171 in synchronization with timing at which the second vibrating unit 112 in a driving state enters a pausing state. The first vibration attenuating unit 160 is connected with the second vibrating unit 112, and attenuates vibration of the vibrating weight 342. Thereby, the attenuation interval of vibration of the second vibrating unit 112 is shortened.

The second switch unit 171 makes the first vibration attenuating unit 160 and the vibrating unit, which are conductive, non-conductive in a switching manner in synchronization with timing at which the second vibrating unit 112 in a pausing state enters a driving state. Then, the second switch unit 171 inputs a drive signal to each drive electrode of the vibrating unit. Thereby, energy consumption by the first vibration attenuating unit 160 is prevented at the time of a driving state.

Specifically, the first vibrating unit 111 and the second vibrating unit 112 electrically consume kinetic energy of the vibrating weight 342 before the vibration direction of the vibrating weight 342 is switched. The first vibration attenuating unit 160 attenuates vibration by electrically consuming the kinetic energy. The first vibration attenuating unit 160 includes an attenuating resistance 161. That is, the first vibration attenuating unit 160 does not have to consume electrical power wastefully because it does not need a special circuit or the like.

The vibration direction switching unit 150 switches driving by providing a pausing period for pausing driving of the first vibrating unit 111 and the second vibrating unit 112 while switching the vibration direction of the vibrating weight 342. Thereby, it is possible to suppress mutual influence between vibration along the first axis and vibration along the second axis.

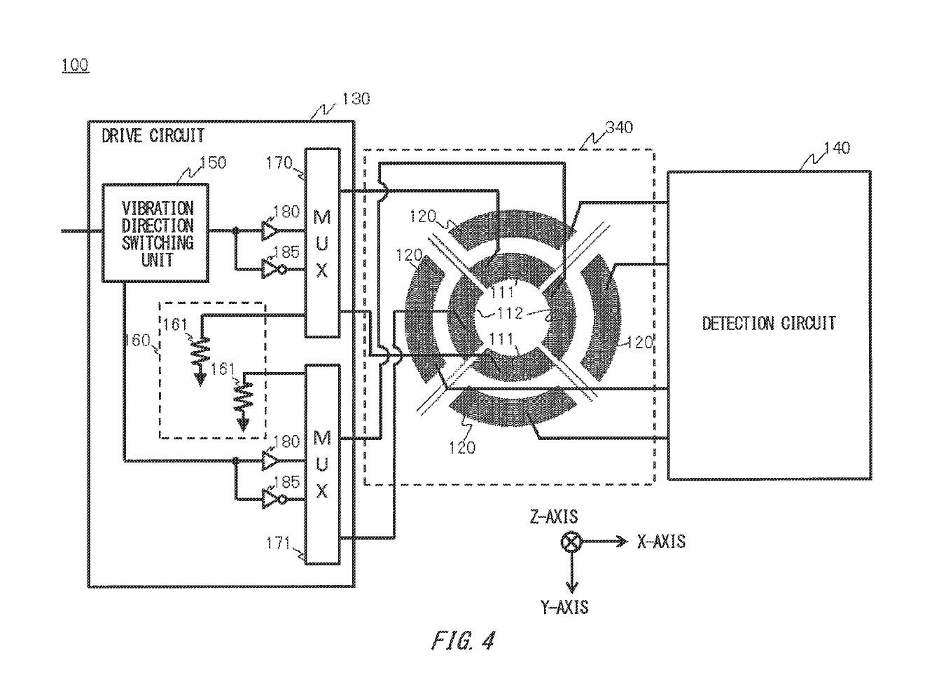

FIG. 4 is a figure illustrating a configuration example of the angular velocity sensor 100 according to an embodiment of the present invention. The angular velocity sensor 100 according to the present embodiment is different from the embodiment of FIG. 3 in that the first vibration attenuating unit 160 is also connected with the first switch unit 170 as well as with the second switch unit 171.

The first vibration attenuating unit 160 is connected with the first vibrating unit 111 and the second vibrating unit 112 via the first switch unit 170 and the second switch unit 171. The first switch unit 170 makes the first vibration attenuating unit 160 and the first vibrating unit 111 conductive or non-conductive in a switching manner The second switch unit 171 makes the first vibration attenuating unit 160 and the second vibrating unit 112 conductive or non-conductive in a switching manner

As one example, the first switch unit 170 and the second switch unit 171 make the first vibration attenuating unit 160 and the vibrating unit, which are non-conductive, conductive in a switching manner in synchronization with timing at which the vibrating unit in a driving state enters a pausing state. The first vibration attenuating unit 160 attenuates vibration simultaneously with switching of the vibration from a steady state interval to an attenuation interval.

Also, the first switch unit 170 and the second switch unit 171 make the first vibration attenuating unit 160 and the vibrating unit, which are conductive, non-conductive in synchronization with timing at which the vibrating unit in a pausing state enters a driving state. Then, a drive signal is input to each drive electrode of the vibrating unit. Thereby, energy consumption by the first vibration attenuating unit 160 is prevented at the time of a driving state.

The angular velocity sensor 100 according to the present embodiment causes the first vibration attenuating unit 160 to consume kinetic energy not only before the vibration direction is changed from the first axis to the second axis, but also before the vibration direction is changed from the second axis to the first axis. Accordingly, the angular velocity sensor 100 can shorten an attenuation interval of vibration along both the first axis and the second axis.

The first vibration attenuating unit 160 according to the present embodiment has the attenuating resistances 161 corresponding to the first switch unit 170 and the second switch unit 171, respectively. Resistance values that are optimum for kinetic energy to be electrically consumed corresponding to the first vibrating unit 111 and the second vibrating unit 112 are set for the attenuating resistances 161.

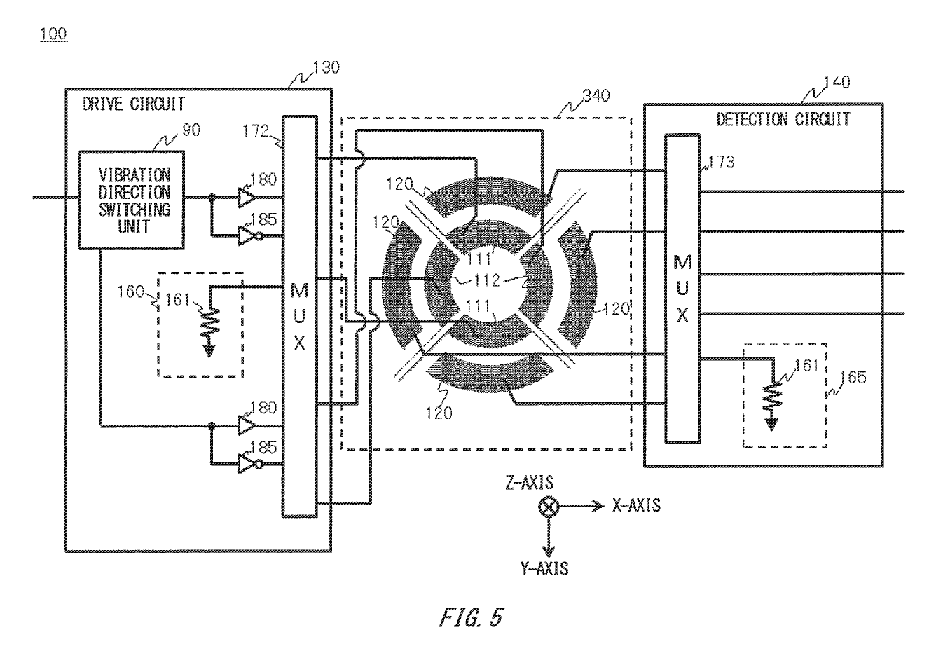

FIG. 5 is a figure illustrating a configuration example of the angular velocity sensor 100 according to an embodiment of the present invention. The angular velocity sensor 100 according to the present embodiment is different from the embodiment of FIG. 4 in that it has a third switch unit 172 in place of the first switch unit 170 and the second switch unit 171. FIG. 5 shows a specific configuration example of the detection circuit 140.

The third switch unit 172 makes the first vibration attenuating unit 160 and the first vibrating unit 111 conductive or non-conductive in a switching manner and makes the first vibration attenuating unit 160 and the second vibrating unit 112 conductive or non-conductive in a switching manner. As one example, the third switch unit 172 makes the first vibration attenuating unit 160 and the first vibrating unit 111 conductive or non-conductive in a switching manner in synchronization with timing at which the vibrating unit in a driving state enters a pausing state or the vibrating unit in a pausing state enters a driving state.

Specifically, the third switch unit 172 makes the first vibration attenuating unit 160 and the first vibrating unit 111 conductive in synchronization with timing at which a driving state turns into a pausing state. Also, the third switch unit 172 makes the first vibration attenuating unit 160 and the first vibrating unit 111 non-conductive in synchronization with timing at which a pausing state turns into a driving state.

The first vibration attenuating unit 160 is connected with the first vibrating unit 111 in an attenuation interval of vibration along the first axis. Thereby, the attenuation interval in the direction of the first vibration is shortened most.

The first vibration attenuating unit 160 is connected with the first vibrating unit 111 in a pausing state of vibration along the first axis. Thereby, vibration of the vibrating weight 342 having occurred in an intermittent interval is attenuated.

Next, vibration along the second axis is explained. The third switch unit 172 makes the first vibration attenuating unit 160 and the second vibrating unit 112 conductive or non-conductive in a switching manner in synchronization with timing at which the vibrating unit in a driving state enters a pausing state or the vibrating unit in a pausing state enters a driving state.

Specifically, the third switch unit 172 makes the first vibration attenuating unit 160 and the second vibrating unit 112 conductive in synchronization with timing at which a driving state turns into a pausing state. Also, the third switch unit 172 makes the first vibration attenuating unit 160 and the second vibrating unit 112 non-conductive in synchronization with timing at which a pausing state turns into a driving state.

The first vibration attenuating unit 160 is connected with the second vibrating unit 112 in an attenuation interval of vibration along the second axis. Thereby, the attenuation interval in the second direction of vibration is shortened most.

The first vibration attenuating unit 160 is connected with the second vibrating unit 112 in a pausing state of vibration along the second axis. Thereby, an interval during which vibration of the vibrating weight 342 having occurred in a pausing state is attenuated becomes the largest.

The angular velocity sensor 100 according to the present embodiment can shorten attenuation intervals of vibration along both the first axis and the second axis. Also, because the first vibration attenuating unit 160 is connected with the first vibrating unit 111 or the second vibrating unit 112 in a pausing state, vibration of the vibrating weight 342 having occurred in a pausing state is attenuated.

Next, configuration on the detection circuit 140 side is explained. The detection circuit 140 includes a second vibration attenuating unit 165 and a fourth switch unit 173. The fourth switch unit 173 makes the second vibration attenuating unit 165 and the output unit 120 conductive or non-conductive in a switching manner

The fourth switch unit 173 makes the second vibration attenuating unit 165 and the output unit 120 conductive or non-conductive in a switching manner in synchronization with timing at which the vibrating unit in a driving state enters a pausing state or the vibrating unit in a pausing state enters a driving state. The second vibration attenuating unit 165 is connected with the output unit 120 via the fourth switch unit 173, and attenuates vibration of the vibrating weight 342 by consuming kinetic energy of the vibrating weight 342.

The output unit 120 according to the present example has four detection electrodes outside four drive electrodes. The second vibration attenuating unit 165 may be connected with all the detection electrodes in the output unit 120 via the fourth switch unit 173. Thereby, kinetic energy of the vibrating weight 342 can be consumed by the second vibration attenuating unit 165 as well as by the first vibration attenuating unit 160, an attenuation interval is shortened.

Specifically, the second vibration attenuating unit 165 attenuates vibration by electrically consuming kinetic energy of the vibrating weight 342. Also, the second vibration attenuating unit 165 includes the attenuating resistance 161. That is, the first vibration attenuating unit 160 does not have to consume electrical power wastefully because it does not need a special circuit or the like.

In the present embodiment, the drive circuit 130 and the detection circuit 140 include the attenuating resistances 161. However, even if only the detection circuit 140 includes the attenuating resistance 161, an attenuation interval can be shortened. Also, the detection circuit 140 shown in FIG. 3 and FIG. 4 may have the first vibration attenuating unit 160 or the second vibration attenuating unit 165.

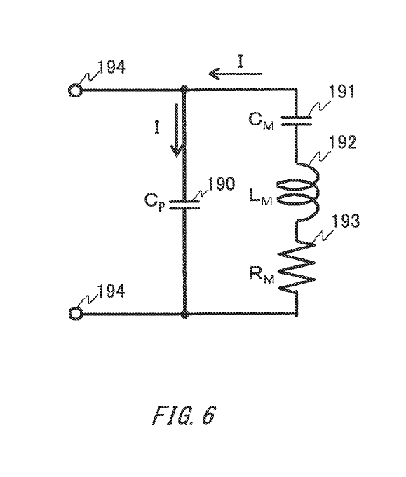

FIG. 6 is a circuit diagram illustrating an equivalent circuit of a piezoelectric element. The piezoelectric element is an electromechanical converting element, and is represented as a circuit shown in FIG. 6 as an electrical equivalent circuit. A piezoelectric body capacitance 191, an inductance 192 and a piezoelectric body resistance 193 are connected in series between two terminals 194. An electrode capacitance 190 is connected in parallel with the piezoelectric body capacitance 191, the inductance 192 and the piezoelectric body resistance 193. The terminals 194 are free ends at the time of mechanical resonance.

The electrode capacitance 190 is a capacitance between the drive electrodes 346. The piezoelectric body capacitance 191, the inductance 192 and the piezoelectric body resistance 193 are an equivalent circuit of the piezoelectric body 345. Current I flows through the equivalent circuit of the piezoelectric body 345 at the time of mechanical resonance. The current I is proportional to mechanical velocity of vibration of the vibrating weight 342.

Mechanical resonance refers to a state where the current I is flowing at resonant frequency fr represented as

fr=½π\sqrt{L_{M}C_{M}} [Equation 1]

Here, L_{M} denotes the inductance 192 of the piezoelectric body 345, and C_{M} denotes the piezoelectric body capacitance 191 of the piezoelectric body 345.

In the equivalent circuit shown in FIG. 6, when the current I flows through the equivalent circuit of the piezoelectric body 345, kinetic energy is consumed only by the piezoelectric body resistance 193 with a resistance value R_{M}. However, the piezoelectric body resistance 193 with the resistance value R_{M} is not sufficient to consume electrical power singly, and an attenuation interval cannot be shortened sufficiently.

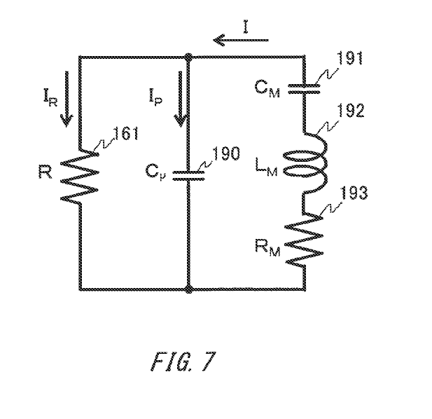

FIG. 7 is a circuit diagram illustrating an equivalent circuit of a piezoelectric element provided with the attenuating resistance 161. The equivalent circuit is different from the equivalent circuit shown in FIG. 6 in that the attenuating resistance 161 is provided between the terminals 194 of FIG. 6.

The attenuating resistance 161 is provided in parallel with a capacitance of the drive electrodes 346 connected with the first vibrating unit 111 or the second vibrating unit 112. In the present embodiment, because kinetic energy is consumed also with the attenuating resistance 161, velocity of the piezoelectric body 345 can be lowered effectively.

The current I occurs in proportion to mechanical velocity of vibration of the vibrating weight 342, and flows through the electrode capacitance 190 of the drive electrodes 346 and the attenuating resistance 161. The current I is divided into current I_{R} to flow through the attenuating resistance 161 and current I_{P} to flow through the electrode capacitance 190. That is, because electrical power is consumed by the attenuating resistance 161 as well as by the piezoelectric body resistance 193, an attenuation interval of vibration can be shortened.

The resistance value R of the attenuating resistance 161 may be equal to the absolute value of an impedance of the electrode capacitance 190 of the drive electrodes 346 at the resonant frequency of the first vibrating unit 111 or the second vibrating unit 112. In this case, the current I_{R} to flow through the attenuating resistance 161 and the current I_{P} to flow through the electrode capacitance 190 become equal to each other, and the current I_{R} becomes the largest. Accordingly, the amount of kinetic energy consumed by the attenuating resistance 161 and the piezoelectric body resistance 193 becomes the largest.

In the present embodiment, the electrode capacitance 190 is explained as an electrode capacitance between the drive electrodes 346. However, the electrode capacitance 190 may be an electrode capacitance of the detection electrodes 347.

When the attenuating resistance 161 is provided to each of the drive circuit 130 and the detection circuit 140, the electrode capacitance 190 changes depending on each electrode area of the first vibrating unit 111, the second vibrating unit 112 and the output unit 120. Accordingly, the effect of attenuating vibration becomes high when an attenuating resistance 161 corresponding to the absolute value of each impedance of the electrode capacitance 190 is selected. The respective attenuating resistances 161 may have impedances corresponding to the area of an electrode with which they are connected.

In the present specification, a piezoelectric element-type sensor that vibrates the vibrating weight 342 by using the piezoelectric body 345 for the MEMS 340 is used as the angular velocity sensor 100. However, an electrostatic capacitance-type angular velocity sensor that vibrates the vibrating weight 342 by the MEMS 340 using an electrostatic capacitance may be used as the angular velocity sensor 100. Because kinetic energy of the vibrating weight 342 can be converted into current also by using the electrostatic capacitance-type angular velocity sensor, the first vibration attenuating unit 160 can attenuate vibration.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

As is apparent from the explanation above, an angular velocity sensor to attenuate vibration of a vibrating weight can be realized by an embodiment of the present invention.

What is claimed is:

1. An angular velocity sensor comprising:
a drive circuit to generate a drive signal;
a vibrating weight;
a vibrating unit to vibrate the vibrating weight along a first axis and a second axis according to the drive signal;
an output unit to output a signal based on Coriolis force that occurs corresponding to angular velocity and vibration of the vibrating weight;
a detection circuit to detect the angular velocity from the signal based on the Coriolis force;
a first vibration attenuating unit to electrically consume kinetic energy of the vibrating weight, the first vibration attenuating unit including a resistance; and
a vibration direction switching unit to switch driving of the vibrating unit, and switch a vibration direction of the vibrating weight from one of the first axis and the second axis to the other, wherein
the vibrating unit is connected to the resistance before the vibration direction switching unit switches the vibration direction.

2. The angular velocity sensor according to claim 1, wherein the first vibration attenuating unit electrically consumes kinetic energy of the vibrating weight before the vibration direction switching unit switches the vibration direction.

3. The angular velocity sensor according to claim 1, wherein the vibration direction switching unit provides a pausing period for pausing driving of the vibrating unit before switching the vibration direction.

4. The angular velocity sensor according to claim 3, wherein the drive circuit is configured to have the vibration direction switching unit and the first vibration attenuating unit, and further has a first switch unit to make the first vibration attenuating unit and the vibrating unit conductive or non-conductive in a switching manner.

5. The angular velocity sensor according to claim 4, wherein the first switch unit in a non-conductive state enters a conductive state in synchronization with timing at which the vibrating unit in a driving state enters a pausing state.

6. The angular velocity sensor according to claim 5, wherein the first switch unit in a conductive state enters a non-conductive state in synchronization with timing at which the vibrating unit in a pausing state enters a driving state.

7. The angular velocity sensor according to claim 3, wherein
the vibrating unit has:
a second vibrating unit including two drive electrodes arrayed along the first axis; and
a first vibrating unit including two drive electrodes arrayed along a perpendicular direction to the first axis, and
the first vibration attenuating unit is connected with the first vibrating unit and the second vibrating unit.

8. The angular velocity sensor according to claim 7, wherein the drive circuit further has a second switch unit to make the first vibration attenuating unit and the second vibrating unit conductive or non-conductive in a switching manner.

9. The angular velocity sensor according to claim 8, wherein the second switch unit in a non-conductive state enters a conductive state in synchronization with timing at which the vibrating unit in a driving state enters a pausing state.

10. The angular velocity sensor according to claim 9, wherein the second switch unit in a conductive state enters a non-conductive state in synchronization with timing at which the vibrating unit in a pausing state enters a driving state.

11. The angular velocity sensor according to claim 1, wherein
the vibrating unit has:
a second vibrating unit including two drive electrodes arrayed along the first axis; and
a first vibrating unit including two drive electrodes arrayed along a perpendicular direction to the first axis,
the first vibration attenuating unit is connected with the first vibrating unit and the second vibrating unit, and
the drive circuit further has a third switch unit to make the first vibration attenuating unit and the first vibrating unit conductive or non-conductive in a switching manner and make the first vibration attenuating unit and the second vibrating unit conductive or non-conductive in a switching manner.

12. The angular velocity sensor according to claim 11, wherein the third switch unit makes the first vibration attenuating unit and the first vibrating unit conductive or non-conductive in a switching manner in synchronization with timing at which the vibrating unit in a driving state enters a pausing state or the vibrating unit in a pausing state enters a driving state; and makes the first vibration attenuating unit and the second vibrating unit conductive or non-conductive in a switching manner in synchronization with timing at which the vibrating unit in a driving state enters a pausing state or the vibrating unit in a pausing state enters a driving state.

13. The angular velocity sensor according to claim 1, wherein the resistance is provided in parallel with a capacitance between drive electrodes connected with the vibrating unit.

14. The angular velocity sensor according to claim 13, wherein a resistance value of the resistance is equal to an absolute value of an impedance of the capacitance between the drive electrodes at a resonant frequency of the vibrating unit.

15. The angular velocity sensor according to claim 1, wherein the detection circuit further has a second vibration attenuating unit to electrically consume the kinetic energy, the detection circuit being connected with the output unit.

16. The angular velocity sensor according to claim 15, wherein the detection circuit further has a fourth switch unit to make the second vibration attenuating unit and the output unit conductive or non-conductive in a switching manner.

17. The angular velocity sensor according to claim 16, wherein the fourth switch unit enters a conductive state or a non-conductive state in synchronization with timing at which the vibrating unit in a driving state enters a pausing state or the vibrating unit in a pausing state enters a driving state.

18. The angular velocity sensor according to claim 1, wherein
the drive circuit is configured to have the vibration direction switching unit, and
the detection circuit is configured to have the first vibration attenuating unit.

19. The angular velocity sensor according to claim 18, wherein the first vibration attenuating unit has a resistance.

20. The angular velocity sensor according to claim 18, wherein the vibration direction switching unit provides a pausing period for pausing driving of the vibrating unit before switching a vibration direction of the vibrating weight.

21. The angular velocity sensor according to claim 20, wherein the detection circuit further has a fifth switch unit to make the first vibration attenuating unit and the output unit conductive or non-conductive in a switching manner.

22. The angular velocity sensor according to claim 21, wherein the fifth switch unit in a non-conductive state enters a conductive state in synchronization with timing at which the vibrating unit in a driving state enters a pausing state.

23. The angular velocity sensor according to claim 22, wherein the fifth switch unit in a conductive state enters a non-conductive state in synchronization with timing at which the vibrating unit in a pausing state enters a driving state.

24. The angular velocity sensor according to claim 19, wherein the resistance is provided in parallel with a capacitance between detection electrodes connected with the output unit.

25. The angular velocity sensor according to claim 24, wherein a resistance value of the resistance is equal to an absolute value of an impedance of the capacitance between the detection electrodes at a resonant frequency of the output unit.

26. A driving method of an angular velocity sensor, the driving method comprising:
vibrating a vibrating weight of the angular velocity sensor along a first axis;
electrically consuming kinetic energy of the vibrating weight by a resistance; and
vibrating the vibrating weight along a second axis.

27. The driving method of an angular velocity sensor according to claim 26, wherein the electrically consuming the kinetic energy is performed before the vibrating the vibrating weight along the second axis.
